(19) United States
(12) Patent Application Publication
(10) Pub. No.: US 2018/0155980 A1
(43) Pub. Date: Jun. 7, 2018

(54) ONE-WAY BRAKING/COILING MECHANISM FOR A HORIZONTAL VENETIAN BLIND WITHOUT PULL CORDS

(71) Applicant: HANS HONG, CHANGHUA COUNTY 514 (TW)

(72) Inventor: HANS HONG, CHANGHUA COUNTY 514 (TW)

(21) Appl. No.: 15/367,686

(22) Filed: Dec. 2, 2016

(51) Int. Cl. E06B 9/322; E06B 9/325

(52) U.S. Cl. CPC E06B 9/322; E06B 2009/3222; E06B 9/325

(57) ABSTRACT

A venetian blind assembly includes a headrail, a horizontal venetian blind, and a coiling mechanism for controlling coiling and release of a transmission cord having a first end connected to the coiling mechanism and a second end fixed to the horizontal venetian blind. A box is mounted on a side of the coiling mechanism. The transmission cord extends through the box. A shaft is mounted between two brackets in the box. A wheel is mounted around the shaft and includes a plurality of teeth. A shaft rotating member is mounted between the two brackets and includes a pressing/engaging plate normally located between two adjacent teeth of the wheel under action of gravitational force. The first end of the transmission cord is wound around the shaft and then extends away from the shaft in a direction opposite to a downward swaying direction of the pressing/engaging plate.

### BACKGROUND OF THE INVENTION

The present invention relates to a horizontal venetian blind assembly without pull cords and, more particularly, to a one-way braking/coiling mechanism for a transmission cord of a horizontal venetian blind without pull cords.

Horizontal venetian blinds are generally used to open and close slats. Current horizontal venetian blinds gradually adopt designs without pull cords to avoid playful children from being entangled by the exposed length of the pull cord (for safety consideration) and to avoid troublesomeness. The “cordless” horizontal venetian blinds generally have no pull cords for manual controlling of the horizontal venetian blinds. Instead, the cordless horizontal venetian blinds use a coiling mechanism to proceed with braking or release of a transmission cord extending through the slats. When the slats are to be extended, the slats must not be pulled backward by the coiling mechanism. Nevertheless, when it is desired to coil the transmission cord, precise coiling must be achieved by the coiling mechanism.

U.S. Pat. No. 7,025,107 B2 discloses a one-way tensioning mechanism for a cordless blind. When the shade or the slats of a venetian blind are to be folded or unfolded, the shade or the slats will not be pulled backward by a coiling mechanism through use of the one-way tensioning mechanism. On the other hand, the shade or the slats can be folded by the coiling mechanism when it is desired to do so. However, the one-way tensioning mechanism complicates the structure and lacks a stable shaft rotating member, such that smooth folding cannot be achieved when the transmission cord is coiled for folding the shade or the slats of the venetian blind.

### BRIEF SUMMARY OF THE INVENTION

In view of the above problems, the present invention provides a venetian blind assembly without pull cords. The venetian blind assembly includes a headrail, a horizontal venetian blind mounted below the headrail, and a coiling mechanism mounted to the headrail. A transmission cord includes a first end connected to the coiling mechanism and a second end fixed to the horizontal venetian blind. The coiling mechanism controls coiling and release of the transmission cord to proceed with folding and unfolding of the horizontal venetian blind. A one-way braking/coiling box is mounted on a side of the coiling mechanism. The transmission cord extends through the one-way braking/coiling box. Two brackets are mounted in the one-way braking/coiling box. A shaft is mounted between the two brackets. A wheel is mounted around the shaft and includes a plurality of teeth on an outer periphery thereof. A shaft rotating member is mounted between the two brackets and includes a pressing/engaging plate disposed on a side thereof. The pressing/engaging plate is normally located between two adjacent teeth of the wheel under action of gravitational force when the pressing/engaging plate is not subjected to any other external force. The first end of the transmission cord is wound around the shaft and then extends away from the shaft in a direction opposite to a downward swaying direction of the pressing/engaging plate.

The present invention utilizes a simple mechanism to proceed a one-way braking (pressing) of the transmission cord. Furthermore, the lower beam and the transmission cord can be manually and slightly lifted to change the pressing state, thereby loosening the transmission cord. Thus, the mechanism of the present invention is simpler. Furthermore, the pressing/engaging plate is mounted on a side of the shaft rotating member. Even the pivotal status and the pressing angle are changed, the shaft rotating member can rotate stably to permit stable coiling of the transmission cord.

The present invention will become clearer in light of the following detailed description of illustrative embodiments of this invention described in connection with the drawings.

### DESCRIPTION OF THE DRAWINGS

FIG. 1 is an exploded, perspective view of a main part of a venetian blind assembly utilizing a one-way braking/coiling mechanism according to the present invention.

FIG. 2 is a perspective view of the venetian blind assembly utilizing the one-way braking/coiling mechanism according to the present invention.

FIG. 3 is a perspective view, partly cutaway, of a one-way braking/coiling box according to the present invention.

FIG. 4 is a side view of the one-way braking/coiling box of FIG. 3.

FIG. 5 is an exploded, perspective view of the one-way braking/coiling box of FIG. 3.

FIG. 6 is a perspective view of the one-way braking/coiling box of FIG. 5.

FIG. 7 is a view similar to FIG. 4, illustrating use of the one-way braking/coiling box.

FIG. 8 is an exploded, perspective view of a folding mechanism of the venetian blind assembly according to the present invention.

### DETAILED DESCRIPTION OF THE INVENTION

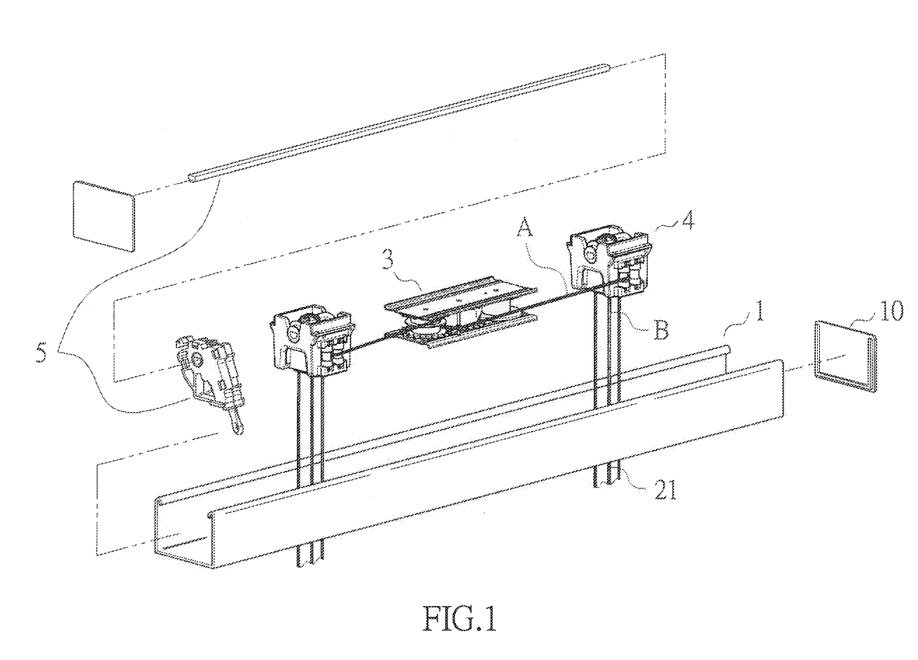

With reference to FIG. 1, the present invention provides a venetian blind assembly utilizing a one-way braking/coiling mechanism for a transmission cord of a horizontal venetian blind without pull cords.

The venetian blind assembly according to the present invention includes a headrail 1 and two end caps 10 on two ends of the headrail 1 for closing the components mounted in the headrail 1 to provide a neat, stable structure.

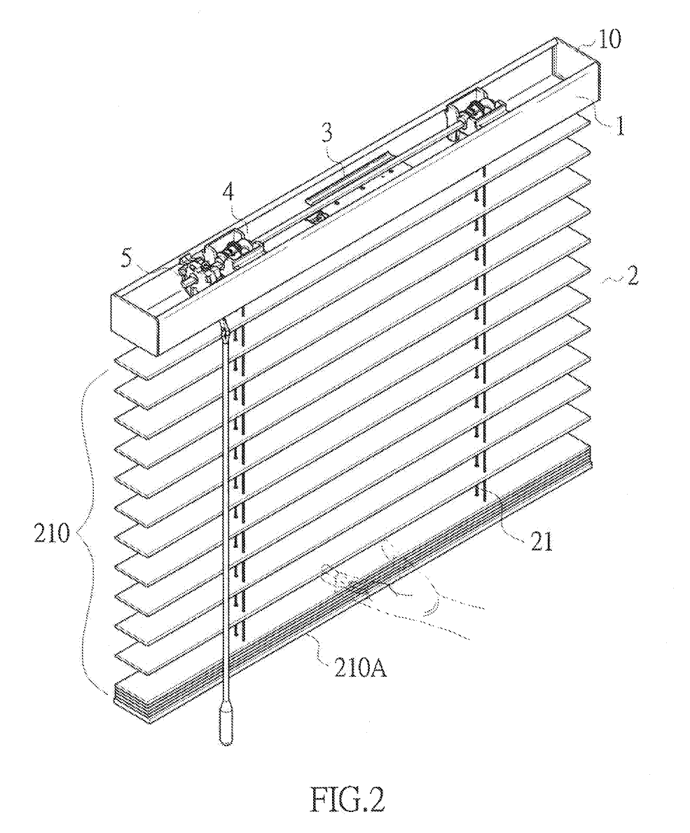

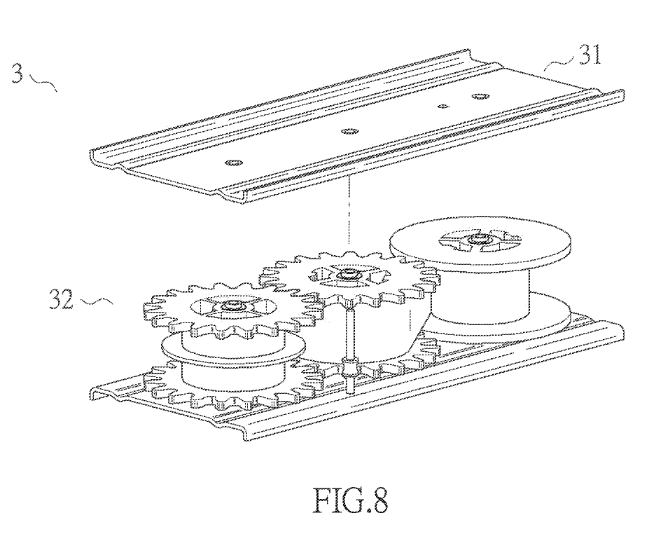

With reference to FIG. 2, a horizontal venetian blind 2 is mounted below the head rail 1. In this embodiment, the horizontal venetian blind 2 includes a plurality of vertically spaced slats 210. With reference to FIG. 8, a coiling mechanism 3 is mounted to the headrail 1 and is covered by a top cover 31. The coiling mechanism 3 includes a spring unit 32 and is conventional. Detailed description of the coiling mechanism 3 is not provided to avoid redundancy.

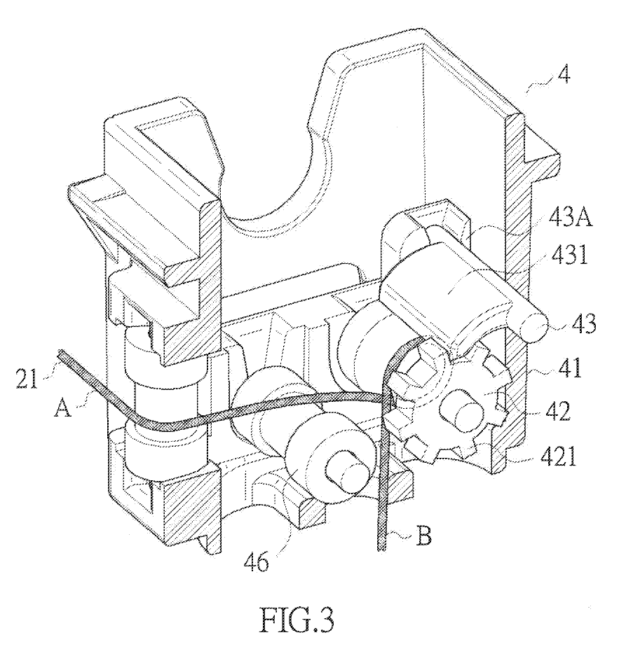

With reference to FIGS. 1 and 3, a transmission cord 21 includes a first end A connected to the coiling mechanism 3 and a second end B fixed to a bottommost portion of the slats 21. Thus, the horizontal venetian blind 2 can be fixed and lifted. Furthermore, the coiling mechanism 3 controls coiling and release of the transmission cord 21 to proceed with folding and unfolding of the horizontal venetian blind 2.

With reference to FIG. 1, an adjusting mechanism 5 is provided to adjust the inclination angle of each slat 210 of the horizontal venetian blind 2.

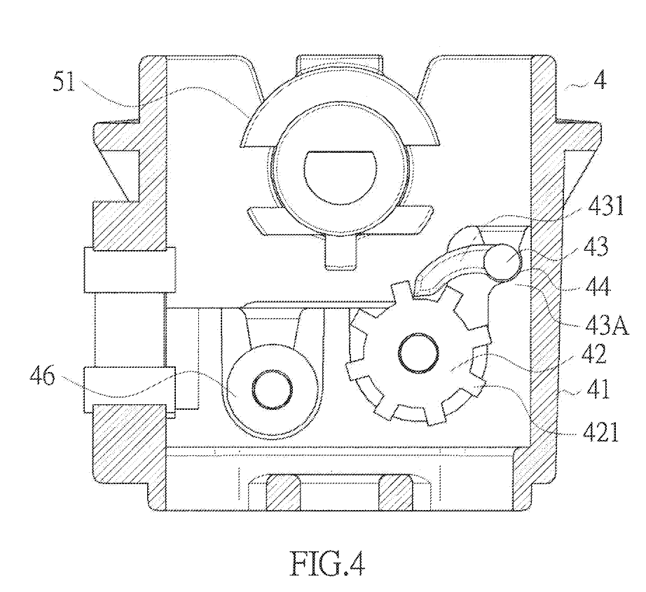

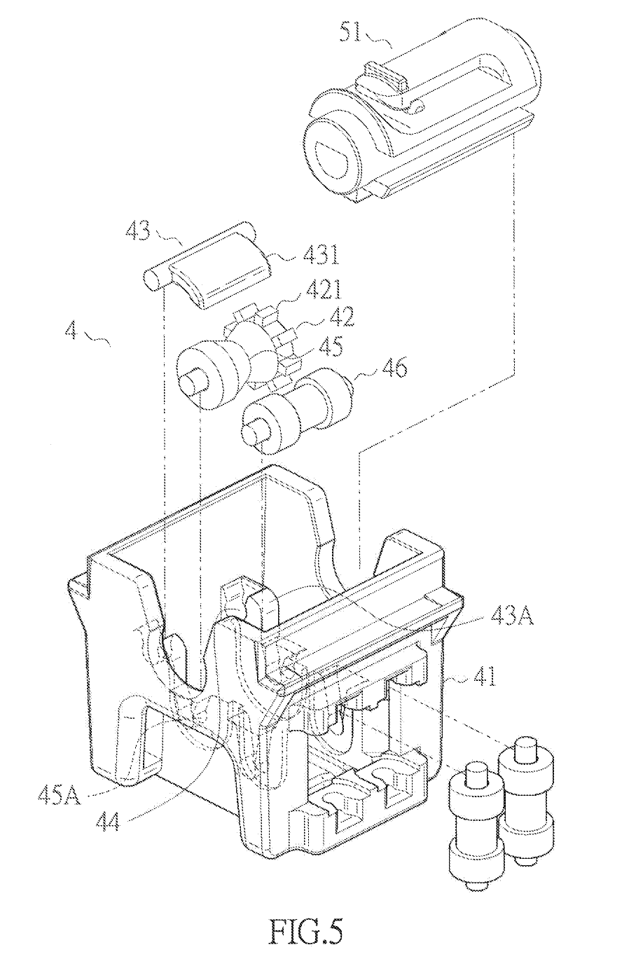

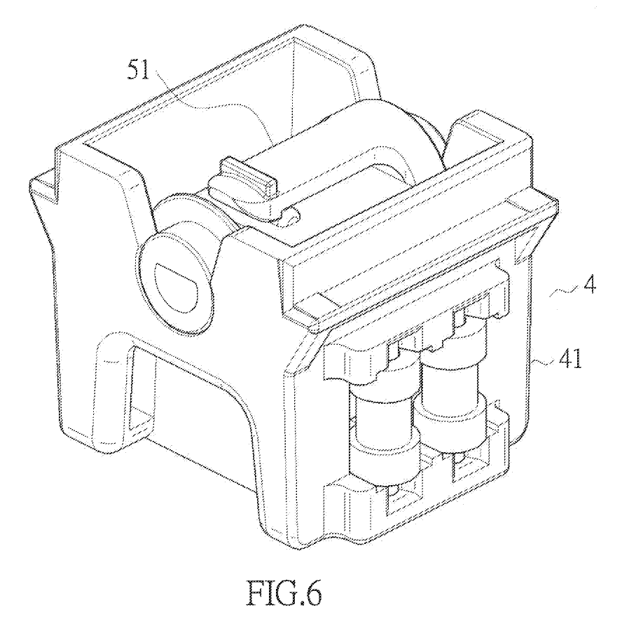

With reference to FIGS. 2-7, a one-way braking/coiling box 4 is mounted on a side of the coiling mechanism 3, and the transmission cord 21 extends through the one-way braking/coiling box 4. In this embodiment, the one-way braking/coiling box 4 includes a box body 41 receiving two brackets 43A and 45A. A shaft 45 is mounted between the two brackets 43A and 45A. A wheel 42 is mounted around the shaft 45 and includes a plurality of teeth 421 on an outer periphery thereof.

Furthermore, a shaft rotating member 43 is mounted between the two brackets 43A and 45A. Each of the two brackets 43A, 45A includes an arcuate groove 44 having an upwardly facing opening. The arcuate grooves 44 are provided for receiving and supporting the shaft rotating member 43. Thus, the shaft rotating member 43 is not impeded at the outer periphery thereof and can pivot easily. The shaft rotating member 43 includes a pressing/engaging plate 431 disposed on a side thereof. The pressing/engaging plate 431 is normally located between two adjacent teeth 421 of the wheel 42 under the action of the gravitational force when the pressing/engaging plate is not subjected to any other external force. By such an arrangement, the pressing/engaging plate 431 can sway easily to make the shaft rotating member 43 rotate, and the pressing/engaging plate 431 can easily fall into a groove between two adjacent teeth 421 of the wheel 42.

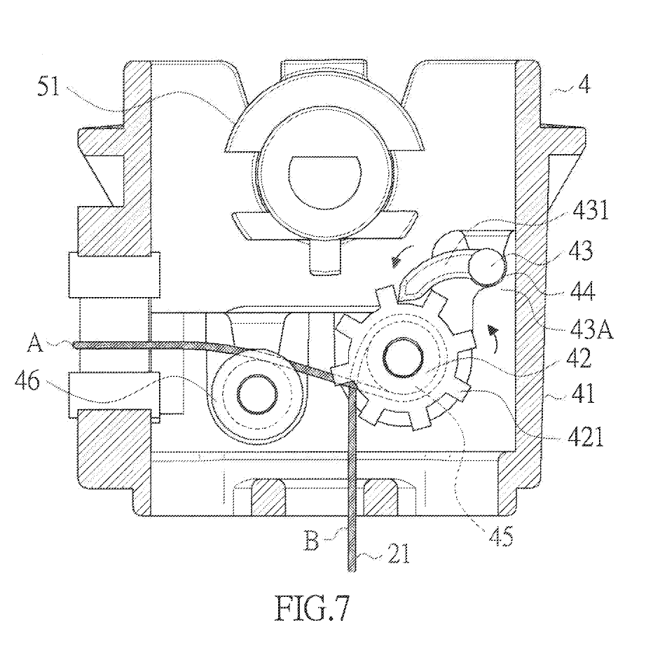

The first end A of the transmission cord 21 is wound around the shaft 45 and then extends away from the shaft 45 in a direction (the forward direction) opposite to a downward swaying direction of the pressing/engaging plate 431 (see FIG. 7). The second end B of the transmission cord 21 is the section extending downward after winding around the shaft 45. The shaft 45 can rotate in a direction (the forward direction) and cannot rotate in the reverse direction due to provision of the pressing/engaging plate 431 engaged in the groove between two adjacent teeth 421.

The wheel 42 can be a ratchet gear, and the teeth 421 of the wheel 42 can be ratchet teeth. The pressing/engaging plate 431 can be a claw. Thus, an escapement mechanism is provided to permit rotation in a single direction.

The adjusting mechanism 5 for the horizontal venetian blind 2 includes a bending tube 51 mounted in the one-way braking/coiling box 4. The adjusting mechanism 5 and the bending tube 51 for adjusting the slats 210 are conventional and, therefore, not described in detail.

With reference to FIGS. 2 and 3, when it is desired to pull the slats 210 of the horizontal venetian blind 2 downward to unfold the slats 210, the second end B of the transmission cord 21 must be pulled. When the transmission cord 21 passes through the one-way braking/coiling box 4, the transmission cord 21 is firstly wound around a guiding wheel 46 mounted on a side of the wheel 42. The guiding wheel 46 provides a guiding function and a supporting function. Then, the transmission cord 21 is wound around the shaft 45. After the transmission cord 21 passes through the one-way braking/coiling box 4, a force can be applied in the forward direction to simultaneously rotate the wheel 42 and the shaft 45 and, thus, pulls the transmission cord 21 downward. Since rotation of the wheel 42 in the reverse direction is prohibited by the pressing/engaging plate 431 that presses and engages with the wheel 42, the coiling mechanism 3 is prevented from being elastically pulled backward.

When it is desired to fold the slats 210 of the horizontal venetian blind 2, a lower beam 210A of the horizontal venetian blind 2 is slightly lifted to slow down downward winding of the transmission cord 21. Furthermore, when the winding state is relieved, the regular elastic returning force of the coiling mechanism 3 can pull back the transmission cord 21. At this time, the engagement between the pressing/engaging plate 431 and the wheel 42 still prevents the reverse rotation, but the lower beam 210A can be slightly lifted to slow down the downward winding of the transmission cord 21. Thus, the regular elastic returning force of the coiling mechanism 3 can pull back the transmission cord 21 to thereby fold the slats 210 of the horizontal venetian blind 2.

In view of the foregoing, the present invention utilizes a simple mechanism to proceed a one-way braking (pressing) of the transmission cord 21. Furthermore, the lower beam 210A and the transmission cord 21 can be manually and slightly lifted to change the pressing state, thereby loosening the transmission cord 21. Thus, the mechanism of the present invention is simpler. Furthermore, the pressing/engaging plate 431 is mounted on a side of the shaft rotating member 43. Even the pivotal status and the pressing angle are changed, the shaft rotating member 43 can rotate stably to permit stable coiling of the transmission cord 21.

Although specific embodiments have been illustrated and described, numerous modifications and variations are still possible without departing from the scope of the invention. The scope of the invention is limited by the accompanying claims.

What is claimed is:

1. A venetian blind assembly comprising:
a headrail;
a horizontal venetian blind mounted below the headrail;
a coiling mechanism mounted to the headrail;
a transmission cord including a first end connected to the coiling mechanism and a second end fixed to the horizontal venetian blind, with the coiling mechanism controlling coiling and release of the transmission cord to proceed with folding and unfolding of the horizontal venetian blind; and
a one-way braking/coiling box mounted on a side of the coiling mechanism, with the transmission cord extending through the one-way braking/coiling box, the with two brackets mounted in the one-way braking/coiling box, with a shaft mounted between the two brackets, with a wheel mounted around the shaft and including a plurality of teeth on an outer periphery thereof, with a shaft rotating member mounted between the two brackets and including a pressing/engaging plate disposed on a side thereof, wherein the pressing/engaging plate is normally located between two adjacent teeth of the wheel under action of gravitational force when the pressing/engaging plate is not subjected to any other external force, and wherein the first end of the transmission cord is wound around the shaft and then extends away from the shaft in a direction opposite to a downward swaying direction of the pressing/engaging plate.

2. The venetian blind assembly as claimed in claim 1, further comprising a guiding wheel mounted on a side of the wheel.

3. The venetian blind assembly as claimed in claim 1, wherein each of the two brackets includes an arcuate groove having an upwardly facing opening.
